(19) United States
(12) Patent Application Publication
(10) Pub. No.: US 2017/0279258 A1
(43) Pub. Date: Sep. 28, 2017

(54) Marker Device

(71) Applicant: Balmoral Engineering Pty Ltd, New South Wales (AU)

(72) Inventor: Enzo MESETI, New South Wales (AU)

(21) Appl. No.: 15/250,255

(22) Filed: Aug. 29, 2016

(30) Foreign Application Priority Data
Mar. 23, 2016 (AU) 2016901106
May 16, 2016 (AU) 2016901814

(51) Int. Cl. H02G 7/00; F16B 2/10; F16M 13/02

(52) U.S. Cl. CPC H02G 7/00; F16M 13/022; F16B 2/10; H02G 2200/20

(57) ABSTRACT

A device adapted for use as a warning marker. The device comprising a device body with a first end and a second end, in which the first end and the second end define a longitudinal axis therebetween. A securing means may be attached to the device body first end. The device body comprising at least one projection projecting at an angle from the longitudinal axis of the device body; and wherein the device body is rotatable about the axis relative to securing means.

The present application claims priority to Australian Patent Application No. 2016901106, filed on Mar. 23, 2016, and Australian Patent Application No. 2016901814, filed on May 16, 2016, which are incorporated herein by reference in their entirety.

### FIELD OF THE INVENTION

The present disclosure relates to a marker device adapted for attachment to an electrically charged item or other suitable object. More particularly, the device adapted to be a visual marker which provides improved visibility and preferably reduces loading on a transmission line, distribution line, power line or other lines relative to known warning markers.

### BACKGROUND OF THE INVENTION

Warning markers are commonly used to highlight transmission lines such that transmission lines are not inadvertently touched or impacted upon. Warning markers are typically required for a number of purposes such as for; warning planes, allowing birds to differentiate transmission lines from a horizon, cable car applications, rope way structures and high-rise transmission lines. These devices are also typically used in agriculture, plants, mining, and construction sites.

Known warning markers include flags and ribbons. These warning markers can easily break or degrade and are not easily visible in certain orientations, particularly due to the relatively narrow dimensions of the device. To view these markers, a viewer would typically be required to stand at a substantially perpendicular orientation relative to the face of the marker. This can cause a number of issues, namely that there is no visual marker clearly visible while a person is oriented in any direction, such as a direction parallel to the face of the marker. In addition, if there are strong winds the markers may be forced into an orientation which is more difficult to view, such as the face of the marker being substantially parallel with the relative ground level.

Further, known warning markers typically induce an adverse loading on transmission lines, not only due to the weight of the marker, but also due to wind loading of the marker. Wind loading of transmission lines can cause damage and potentially cause blackouts or other electrical issues which are costly to repair. As such, there may be a need to provide a device which does not significantly adversely impact and/or load transmission lines.

Other known markers, such as obstruction marking spheres, may provide visual warning in multiple orientations however these devices are cumbersome and are not easily attachable to transmission lines. Notably, the transmission lines are typically required to be turned off, for installation of the obstruction marking spheres which causes power outages due to lines being turned off or cause great expense to install due to the lines being required to be turned off. Further, a user installing the device will typically be required to be in close proximity (i.e. in arms reach) to the transmission line to install the device or remove the device. These spheres also have the additional problems associated with wind loading and which causes stress to be applied to transmission lines, which again, may damage the transmission lines.

Further current devices can only be attached from below a transmission line, or attached via helicopter or from an elevated work platform (such as a cherry picker or basket crane). This can provide a number of problems when attempting to fix a warning marker to lines below infrastructure, such as bridges and the like.

Other markers may be used primarily to reduce the potential for large birds to impact the transmission line as they may become confused between a transmission line and the horizon or do not see the lines. These markers typically called ‘bird diverters’, are generally wound around the transmission lines by hand and comprise a coiled orientation such that the line has a breaker which can assist with birds avoiding the transmission line. To attach these devices generally requires an installer to manually attach the device by hand and therefore, the use of an elevated platform or helicopter is generally required which is costly and time consuming.

In addition, most conventional clamps or securing means are formed from a conductive material, such as an aluminium (aluminium) alloy or galvanised steel. Such materials typically exclude the use of a hot stick or live line attachment method due to the risk of potential electrocution.

An additional problem associated with known markers is creep. Creep of line markers occurs during movement of transmission lines, which causes spaced apart markers to move closer to each other towards their respective nearest transmission line support (i.e. away from the middle of a transmission line) which requires the highest level of attention. Alternatively, the creep of markers may cause the markers to bunch together at a single location on the line.

Any discussion of the prior art throughout the specification should in no way be considered as an admission that such prior art is widely known or forms part of common general knowledge in the field.

### SUMMARY OF THE INVENTION

### Problems to be Solved

It may be advantageous to provide for an improved warning marker.

It may be advantageous to provide a device which is readily attachable and detachable to a transmission line.

It may be advantageous to provide a device which is attachable to an electrically live surface.

It may be advantageous to provide for a warning marker which is adapted to be relesably attached to via a hotstick (hot stick).

It may be advantageous to provide for a warning marker which can be attached to a transmission line from above a transmission line.

It may be advantageous to provide for a warning marker which may reduce loading on a transmission line.

It may be advantageous to provide for a warning marker which may reduce wind loading on a transmission line.

It may be advantageous to provide for a warning marker which is visible from a number of directions.

It may be advantageous to provide for a warning marker to be attached from any angle.

It may be advantageous to provide a warning marker which reduces creep while in use.

It may be advantageous to provide for a marker which is more visible relative to a static marker.

It may be advantageous to provide for a marker which is may reduce loading on a line.

It is an object of the present invention to overcome or ameliorate at least one of the disadvantages of the prior art, or to provide a useful alternative.

### Means for Solving the Problem

A first aspect of the present invention may relate (INTENTIONALLY LEFT BLANK).

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 illustrates a perspective view of an embodiment of a warning marker device of the present disclosure with a plurality of projections;

FIG. 2 illustrates a perspective view of an embodiment of the securing means of the device;

FIG. 3 illustrates a top view of an embodiment of the device of the present disclosure with four projections;

FIG. 4 illustrates a front view of an embodiment of a projection suitable for use with the device of the present disclosure;

FIG. 5 illustrates a perspective view of an embodiment of the device without projections attached to the device body;

FIG. 6 illustrates a perspective view of another embodiment of the device with curved projections;

FIG. 7 illustrates a perspective view of yet another embodiment of the device with curved projections;

FIG. 8 illustrates a top view of the embodiment of the device of FIG. 7; and

FIG. 9 illustrates a bottom view of the embodiment of the device of FIG. 7.

### DETAILED DESCRIPTION

Preferred embodiments of the invention will now be described with reference to the accompanying drawings and non-limiting examples.

The present disclosure is directed towards a device adapted for use with powerlines or transmission lines. The device is preferably adapted to be a warning marker and/or preferably allows the marker to be observed from a number of directions. The device preferably allows the marker to be predominantly visible from a direction which is parallel and/or perpendicular to transmission lines. A direction parallel to the line may also be referred to as ‘along the line’. Throughout this specification, the term “transmission line” may also refer to a power line, a distribution line or any other line or cable.

In at least one embodiment the device 10 is adapted to be viewed from a direction substantially parallel to transmission lines. Viewing the device 10 from multiple directions is advantageous as this may reduce the potential for transmission line incidents to occur. Further as the device 10 can be viewed in a direction which is substantially parallel to the transmission lines, the device 10 may be adapted to have at least one safety marker 180 which is orientated to be viewed in a direction substantially parallel to the transmission line.

A safety marker 180 may be, for example, a retroreflector, a reflector, a light, an LED, or any other marker suitable for reflecting light, or other desired electromagnetic radiation, in a desired direction. The safety marker 180 may be associated with a proximity sensor (not shown) which allows activation of the safety marker, such as a light or LED, only when persons or objects are near to the device 10.

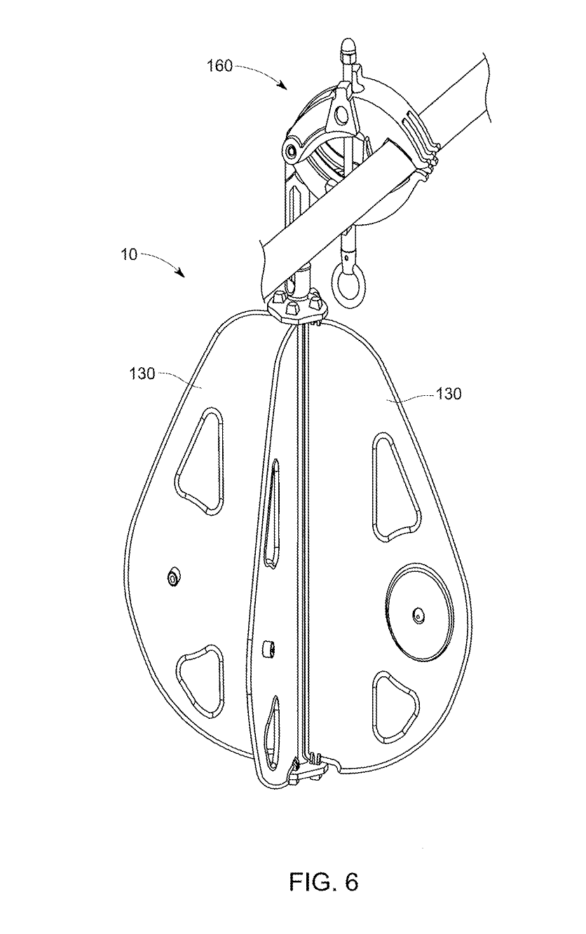

In yet a further embodiment, the device body 110 may be offset from the transmission line which may allow mounting of the device 10 from above or below. An illustration of an embodiment of the device 10 is illustrated as offset in FIG. 6, such that after the device has been attached to the transmission line, the at rest orientation of the device body is offset from the transmission line.

In yet another embodiment, the device body 110 is rotatable relative to the securing means 160, for example via a swivel positioned between the securing means 160 and the device body 110. Rotation between the securing means 160 and the device body 110 may optionally be imparted via an electric motor or possibly by a fluid, for example a wind force. Rotation may generate energy to be stored for later use. For example, an LED may be powered by stored energy during a predetermined time if there is sufficient stored energy.

Optionally, at least one projection 130 of the device 10 is removably attached to the device body 110 by an attachment means 122, 132. The attachment means 122, 132 may be in the form of a male mating means 132 which is adapted to be received in a corresponding female mating means 122 of the device body 110. It will be appreciated that the female and male mating means 122, 132 may be swapped, such that the projections 130 comprise a female mating means and the device body 110 comprises the male mating means. Other attachment means may alternatively be used, such as a clip, a screw, hook and loop fasteners, a bidirectional press fit, or any other suitable means for joining a projection 130 to the device body. Preferably, the projections 130 are formed from a resilient material and bend or flex to allow for interlocking or another predetermined purpose. Preferably, four projections 130 are mounted on, or formed with, the device 10. However, it will be appreciated that any predetermined number of projections 130 may be used which is zero, one, two, three or more. At least one projection 130 may be generally planar in configuration or form.

In yet a further embodiment, the projections 130 may be formed integrally with the device body 110, or be fixed thereto. Projections 130 may be fixed to the device body 110 by welding, ultrasonic welding, gluing, boding, heat bonding, melting, nailing, a press lock fit, a tongue in groove or by any other desired means. A projection 130 may be at least one of; a vane, a spline, an armature, a protrusion, a wing, a fin, a plate, a slat, a sinusoidal projection, or any other predetermined shape.

The device 10 preferably comprises at least one fluid flow means. The fluid flow means is preferably adapted to alter or otherwise direct the flow of a fluid over the device 10. Preferably, the device 10 is adapted to control how fluid flows over and/or around the device 10 such that drag in high winds or wet conditions.

The securing means is preferably releasably attached to the device body 110. The securing means 160 may be adapted to receive a transmission line or other object such that the securing means 160 may form an abutting relationship with the transmission line or other object to retain the transmission line or other object. The securing means 160 may have an adjustment means 168 adapted to allow for manipulation of the securing means 160.

In yet another embodiment, the securing means 160 may be a mounting means, such as a hook, clutch, a clasp, a catch, a pin, a carabiner or the like, which comprises a single surface, or relatively continuous surface, for abutting a transmission line.

The securing means 160 may alternatively be in the form of at least one of; a Cardellini clamp, a gripe clamp, a C-clamp, a G-clamp, a jaw clamp, a three prong clamp, a screw clamp, a toolmakers clamp, a bias clamp, a spring biased clamp, a spring clamp, a speed clamp, a forked clamp, a mousetrap type clamp, or any other suitable securing means 160 for attaching a device 10 to a transmission line. It is preferred that the securing means 160 is removably attached to a transmission line. The securing means 160 may further be an earthing securing means 160, or an earthing clamp.

In an embodiment, the device 10 comprises a device body 110 with a first end 112 and a second end 114 and a securing means 160 attached to the device body 110. The securing means 160 may be releasably attached, fixed to, or formed with the device body 110. The securing means 160 may be attached to one of the device body 110 ends and preferably allows for a movement, such as a rotation, between the securing means 160 and the device body 110.

In a further embodiment, the device 10 may provide for a longer lasting, partially replaceable marker. The device 10 may comprise a plurality of curvatures (see FIGS. 6 and 7 to 9) at a portion of the projections to effect a rotation or other desired effect when fluid interacts with the device. The curvatures may be also referred to as wings and may optionally be removable from the projections 130. The projections 130 may be adapted to be removed from the device body 110 such that the projections 130 can be replaced. Preferably, the polymer is UV stabilised or UV resistant to allow for placement in direct sunlight or other high UV exposure environments. Further, utilising a polymeric material may allow the device to be non-conductive and therefore provide more safety for hotstick (hot stick) installation.

The device 10 may be adapted to be releasably secured to an object, such as a transmission line. The device 10 may also be adapted for use as a data collection device such that environmental data can be captured.

Further embodiments of the device 10 may be similar or dissimilar to that as illustrated, without departing from the nature of the device 10. The device 10 may comprise any suitable means to allow for direct attachment to at least one object, such as a transmission line or other civil infrastructure. The device 10 may reduce a force or load acting on a transmission line relative to the use of other markers, such as flags or spheres. The device may be orientated such that the body of the device is offset relative to the normal between the ground and an object.

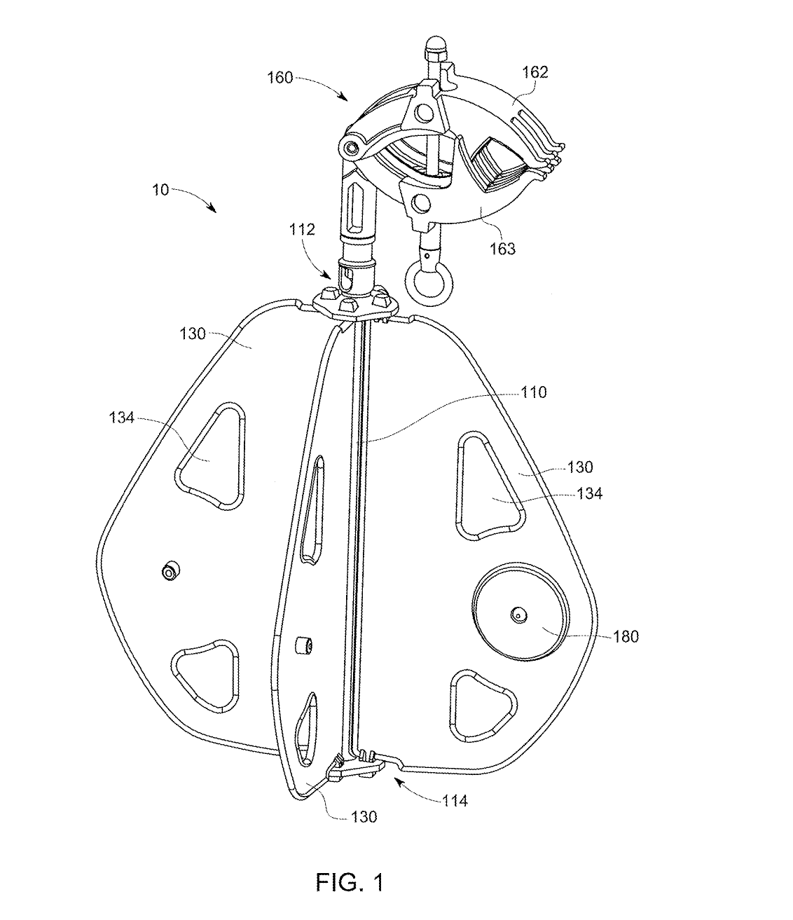

Referring to FIG. 1, there is depicted an embodiment of the device 10 mounted on a transmission line. The device 10 comprises a device body 110 with a first end 112 and a second end 114. The device body 110 optionally comprises at least one support means (not shown) adapted to support a projection 130 when said projection 130 is mounted in the device 10. At least one of the first end 112 and the second end 114 comprises a protuberance 120 with retaining means 122 for retaining a projection 130.

The protuberance 120 preferably comprises a plurality of retaining means 122 adapted to retain at least one projection 130. The projection 130 preferably has a corresponding mounting means 132 which is adapted to be mounted in the retaining means 122. It will be appreciated that the retaining means 122 may be adapted to releasably retain the mounting means 132 therein, or have a one way connection.

The projections 130 further comprise at least one fluid flow means 134 for altering the flow of a fluid over and/or near to the device 10. Altering the flow of a fluid interacting with the device 10 may reduce loading on the device 10 when the device 10 is mounted on a transmission line. Reducing loading on a transmission line may reduce the potential for the transmission line to be damaged in adverse weather conditions, such as high winds or torrential rains.

In yet a further embodiment, the fluid flow means 134 is adapted to generate a pressure differential which may generate lift for the device 10. Lifting the device 10 may reduce the loading on a transmission line when the device 10 is in use.

In yet another embodiment, the fluid flow means 134 is adapted to allow a fluid to impart a rotation of the device body 110 relative to the securing means. Imparting a rotation may reduce a load on the device 10 and therefore reduce a loading on a transmission line when in use. Further, imparting a rotation to the device 10 may direct attention to the device 10 and therefore may improve visual detection of transmission lines. Preferably, the rotational speed can be restricted such that the potential for a joint of bearing failure is reduced. A restrictor may be installed at the mating point between the securing means 160 and the device body 110.

Causing a lift and/or rotation to the device 10 may cause the device 10 to propel in a direction opposing the direction, also referred to herein as a forward motion, of fluid interacting with the device 10. Providing a forward motion may allow the device 10 to further reduce the loading on a transmission line.

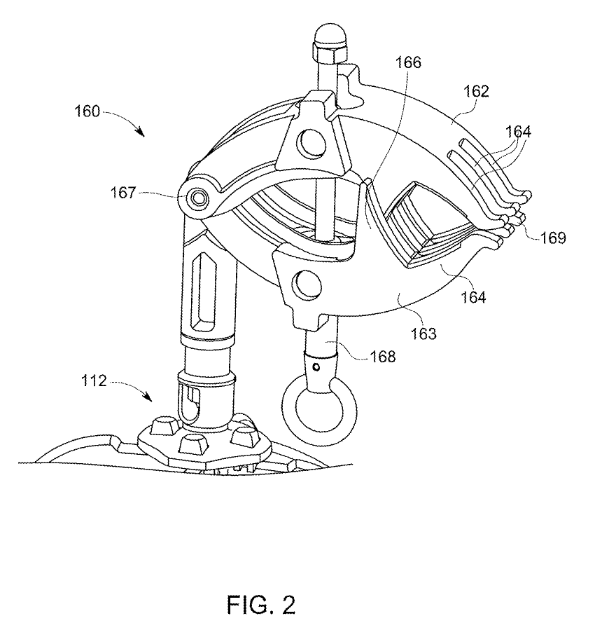

Referring to FIG. 1 and FIG. 2, there is shown an embodiment of a securing means 160 comprises a pair of jaws, first jaw 162, and second jaw 163 which are adapted to form an abutting relationship with a transmission line. The jaws 162, 163 comprise a plurality of prongs 164 in which the prongs 164 of the first jaw 162 can be positioned to optionally interleave with the prongs 164 of the second jaw 163 via actuation of an adjustment means 168. Optionally, more than two prongs are used, and at least three is more preferred. Preferably, the jaws may allow interleaving such that the void between the two jaws 162, 163 can be reduced such that substantially no void exists therebetween the jaws 162, 163. Reducing the void between the jaws may allow for any size of transmission lines to be retained within the jaws, provided that the transmission line diameter is less than the maximum span of the jaws. The adjustment means 168 is preferably positioned between the pivot 167 of the jaws 162, 163 and the lips 169 of the jaws 162, 163. Interleaving prongs 164 of the jaws 162, 163 may reduce or eliminate creep of warning markers. Reducing or eliminating creep of a warning marker 10 is a significant advantage as having warning markers at the correct spacing will provide higher visibility when in use on transmission lines.

It will be appreciated that device 10 may be adapted to have a rotation in a predetermined direction, such that the potential for creep is eliminated or further reduced. Creep may be reduced by having the rotation of the device 10 oppose the direction of creep such that the two forces substantially cancel each other.

In at least one embodiment, the range of the securing means 160 is between 0.1 mm to 150 mm. More preferably, the range of the securing means 160 is between 1 mm to 100 mm. Even more preferably, the range of the securing means 160 is between 2 mm to 50 mm. The adjustment means is optionally in the form of an eye bolt, which may engage respective threads of the upper and/or lower jaws 162, 163. Any other predetermined configuration may also be used to actuate the jaws162, 163. The adjustment means may also be a wing bolt or a bayonet bolt type adjustment means.

At least one of the first jaw 162 and the second jaw 163 further comprises a flange 166, also referred to herein as “finger” 166. The flange 166 may be adapted to restrict a transmission line from contacting the adjustment means 168. Optionally, the adjustment means 168 is formed from at least one of a composite material, a metal or metal alloy. Preferably, the adjustment means 168 may be manipulable by a conventional hotstick (hot stick). A ‘hotstick’ may also be referred to as a ‘live line stick’ or an ‘operating stick’.

In yet a further embodiment, the device can be installed from above, such that a device 10 can be installed from a position elevated above a transmission line, such as a bridge. In one embodiment, if installation is desired from above, the adjustment means may be removed from the device 10 and inverted. In an alternate embodiment, the securing means 160 may be configured to be in an inverted orientation.

The at least one projection 130 of the device 10 further comprise a safety marker 180. Preferably, each projection 130 comprises a safety marker 180 such that a safety marker 180 may be observable near to the device 10 from any direction. This may further enhance the visibility of the device 10 when in use.

Preferably, the securing means 160 is formed at least in part from a polymer such that the securing means 160, when in an abutting relationship with a transmission line, acts as an insulator for the device 10. Providing insulation for the device 10 may allow installation while transmission lines are live.

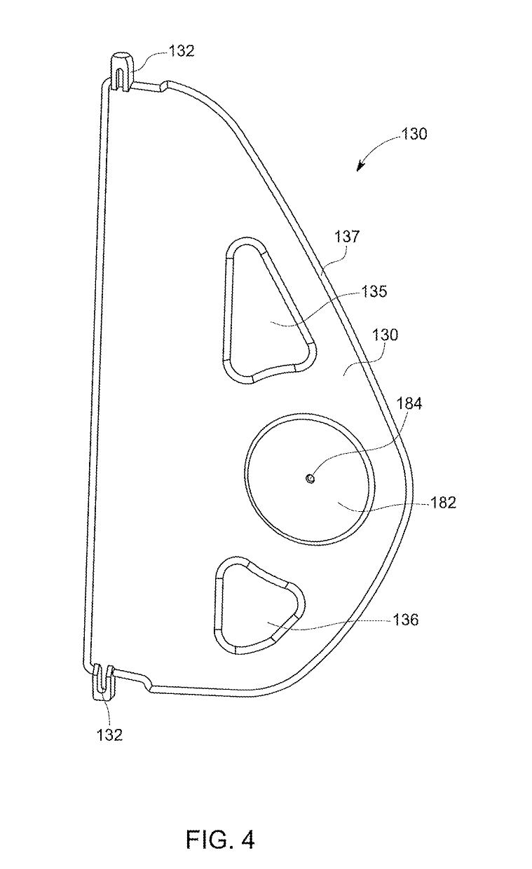

Turning to FIG. 4, there is shown an embodiment of a projection 130 suitable for use with the device 10. The projection 130 comprises mounting means 132, which can be mounted in a retaining means 122 of a protuberance 120 of the device body 110. The projection 130 comprises fluid flow means 134 in the form of two apertures 135, 136 and beads 137. The beads 137 are preferably disposed at the peripheries of the projection 130, which may also provide additional structural support for the projection 130 to resist bending or flexure. Other structural support members or ribbing (not shown) may also be disposed on the projection to resist flexure or bending. The projection 130 may optionally further comprise a safety means mount 182, which is suitable for accepting a safety means 180. An orifice 184 may further be provided for attaching the safety means 180 to the projection 130.

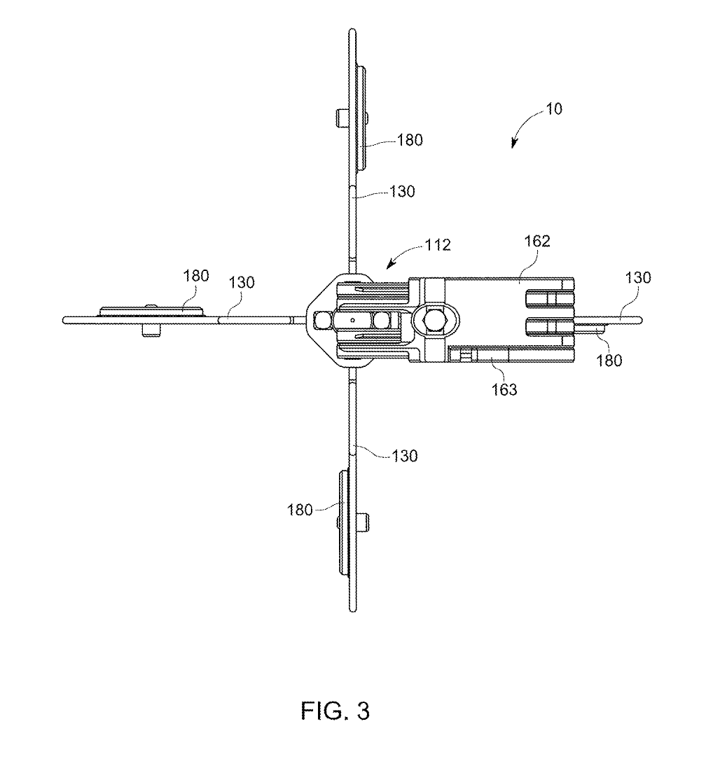

FIG. 3 illustrates a top view of an embodiment of the device 10 with four projections 130. The projections 130 are spaced at substantially equal angles, at around 90 degrees relative to each other. It will be appreciated that the device 10 may comprise at least one projection 130 to function, however preferably at least two projections 130 are disposed on the device. Regardless of the number of projections 130, each of the projections 130 are preferably adapted to be disposed evenly around the axis of the device body 110. For example, if three projections 130 are used, the projections 130 are spaced around 120 degrees relative to one another. However, it may be appreciated that the projections may be disposed asymmetrically relative to one another such that a predetermined effect is imparted to the device 10.

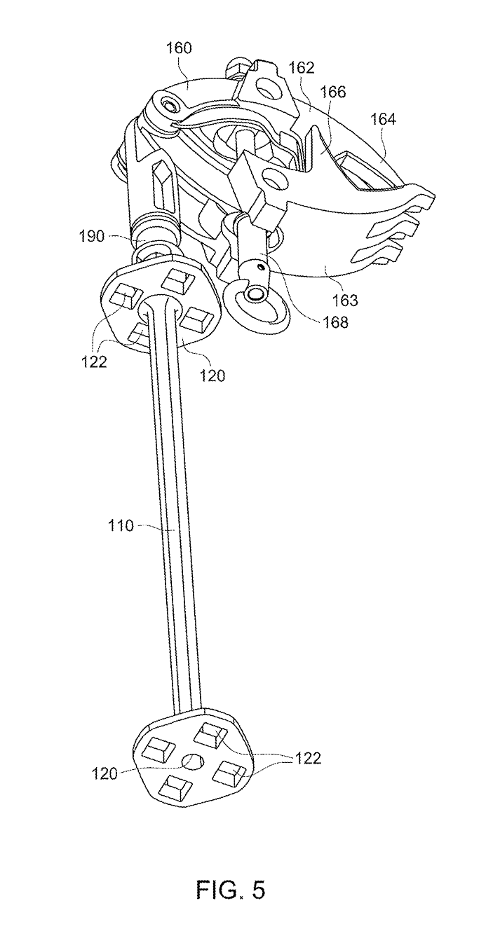

FIG. 5 illustrates a perspective view of the device body 110 without projections 130 installed. The device body 110 may be formed from a longitudinal element, which defines the axis of the device body 110. The longitudinal element may be formed with any cross-sectional shape, such as a circle, a rectangle, a clover shape, or any other predetermined cross section shape. The protuberances 120 comprise a plurality of retaining means 122 which are adapted to receive retaining means 132 of a projection 130. An articulation point 190 is adapted to allow movement, such as a rotation or reorienting of the axis of the device body 110 relative to the securing means 160. It will be appreciated that the device 10 may have more than one articulation point 190 to allow for any predetermined movement of the device 10.

In yet another embodiment, the device body 110 comprises detachable protuberances 120 such that the number of projections 130 mounted to the device may be customised for different applications.

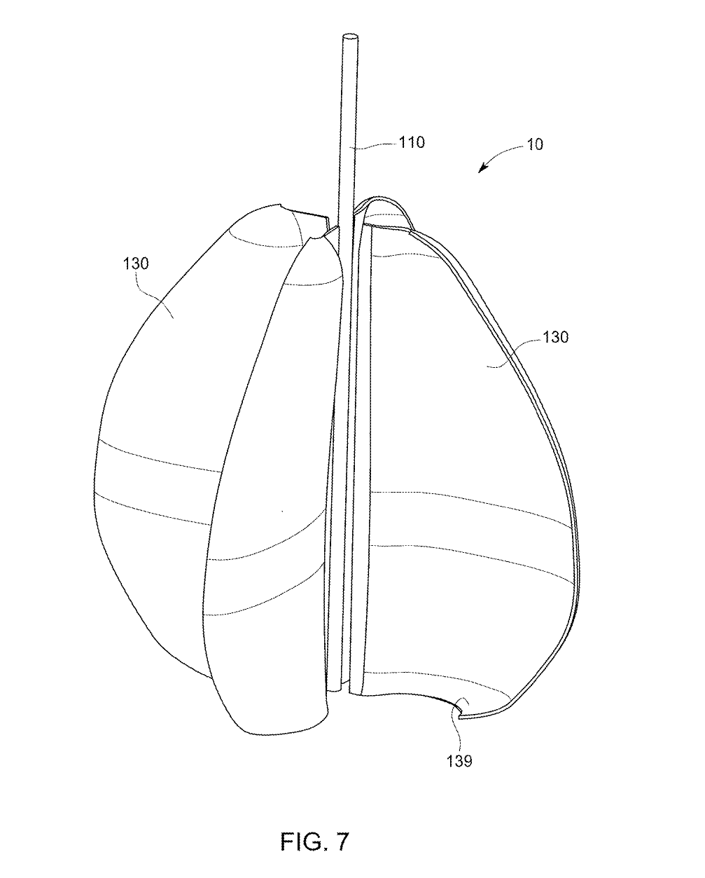

Referring to FIG. 6, there is illustrated another embodiment of the device 10 with a plurality of projections 130. The projections 130 comprise a curvature at one end (see end projections furthest from the securing means 160 in FIG. 6 and/or FIG. 7) such that fluid flowing over the curvatures may impart a rotation on the device 10. It will be appreciated that the entirety of the projection may be curved, or comprise a plurality of curvatures. Rotation of the device body 110 may reduce the strain on a transmission line (relative to other markers) during adverse weather as this may allow dissipation of forces acting on the device 10. The rotation of the device is preferably limited such that the speed of rotation does not negatively impact the stability of the device or cause an undesirable level of friction at the point of rotation. It will be appreciated that at least one curvature may be formed on the projection at any predetermined desirable location.

In yet a further embodiment, the device 10 may comprise a noise generating means adapted to generate a noise or other alert such that birds and other animals may be deterred from going near transmission lines. Noise may be generated via syphoning energy from transmission lines to power the noise generating means. Alternatively, the noise generating means may be activated when the device rotates or has a flow of fluid over the noise generating means. The noise generating means may be adapted to generate noise at a frequency which is outside of the range of normal human hearing, such as subsonic or ultrasonic frequencies.

It yet another embodiment, the device 10 may be adapted syphon energy from a transmission line, or may comprise an energy generation means, such as a solar cell (photovoltaic cell). The energy may be stored in an energy storage means, such as a battery or cell. The securing means 160 may include a split coil transformer to allow for syphoning of power from a transmission line.

In yet a further embodiment, the device 10 may be used to collect data related at least one of; movement of transmission lines, proximity data of the device relative to at least a second device, fluid flow speed data, rainfall data, temperature data, atmospheric data, or any other data desired to be collected. If the device is adapted to collect data, the device may comprise at least one of; a data collection means, a gyroscope, a proximity sensor, a strain sensor, a data storage means, a processor, an accelerometer, WiFi™, magnetometer, barometer, light sensor, a camera, Bluetooth™, a USB port, a data port or any other predetermined sensor or module.

In yet another embodiment, the device 10 the securing means 160 may be a “slap wrap”, which is adapted to wind around a transmission line. The slap wrap securing means (not shown) may be biased in an open position such that it can be attached to a transmission line, and a closed position in which is adapted to allow a device 10 to be releasably secured to a transmission line. It will be appreciated that a pair of slap wraps may be used which may be angled relative to the normal angle between the transmission line and the device body 110 axis, such that the slap wraps extend along a portion of the transmission line. Having the slap wraps extend along the transmission lines may allow for a larger surface area of the transmission lines to be in contact with the surface of the slap wrap, and therefore provide a larger frictional force to retain the device in a desired position.

In yet a further embodiment, the device 10 may comprise a securing means 160 which is formed as a longitudinal element (not shown). The longitudinal element may be adapted to wind around a transmission line or other predetermined object. The longitudinal element may be preformed as a coil or spiral in which each revolution of the spiral may be formed with a different diameter than an adjacent revolution. For example, the spiral may be at least one of; a conical shape, an hourglass shape, a barrel (concave) shape or a reduced end shape. Any other predetermined shape may also be used for attaching the device 10 to a transmission line.

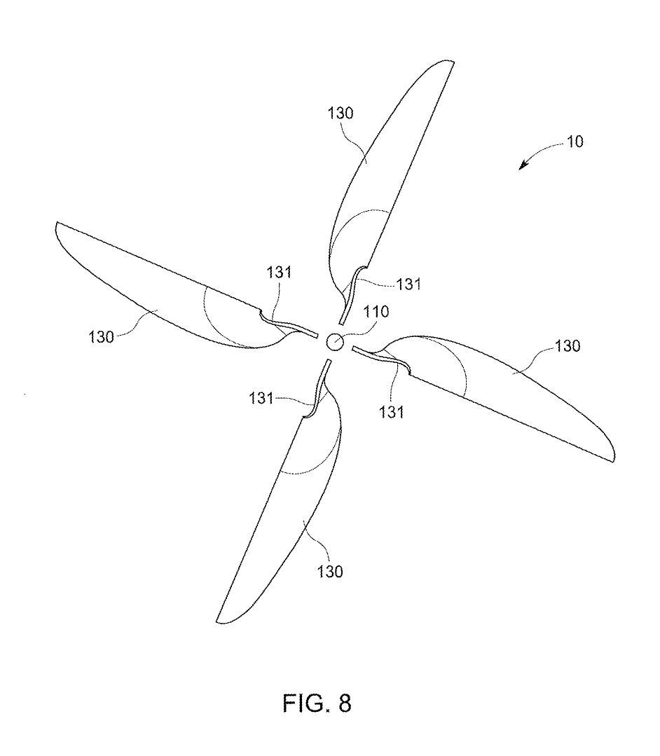

Turning to FIGS. 7 to 9 there is depicted yet another embodiment of the device 10 with a plurality of curved projections 130. The projections 130 are preferably adapted to direct the flow of fluid over the device 10. FIG. 8 is a top view of the device 10 in which the projections of the device comprise a generally “J-shape” 131 curvature formation near to the device body 110 at the first end 112. Conversely, near to the second end 114 of the device body 110 the curved projections preferably comprise a generally “C-shape” 133 curvature formation. Between the first end 112 and the second end 114 of the device at least a portion of the projection 130 comprises at least one positive curvature. It will be appreciated that the projections 130 may be formed with positive and/or negative curvatures.

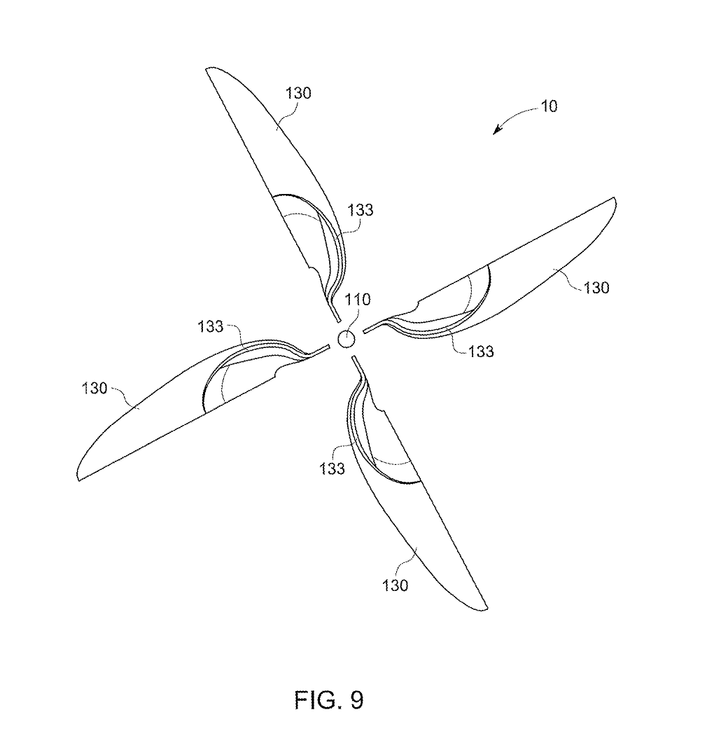

Preferably, the curvature is a generally aerofoil shape when viewed from the top view and/or the bottom view (refer to FIGS. 8 and 9). The portion of the projection furthest from the axis of the device body 110 defined by the first end 112 and the second end 114 is contoured relative to said axis of the device body 110. The lower portion of the contour of the projection may optionally have a pointed portion 139 in which the C-shape curvature defines a portion of the pointed portion 139.

Referring to an unillustrated embodiment, the device 10 may comprise a device body 110 with at least one projection in the form of an airscrew. The airscrew projections preferably have an upper side and a lower side. Preferably, two projections in the form of airscrews helically extend along the length of the device body 110. In one example, the airscrews are similar in formation to that of a Leonardo Da Vinci airscrew type arrangement. It will be appreciated that the airscrew dimensions may be linear or may taper at portions of the screw formation.

While FIGS. 7 to 9 are illustrated with the projections 130 spaced from the device body 110, it will be appreciated that the projections are mounted in retaining means of a protuberance 120 (not shown in FIGS. 7 to 9). In yet another embodiment, the projections 130 may abut the device body 110.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

What is claimed is:

1. A device adapted for use as a warning marker, the device comprising;
a device body with a first end and a second end, the first end and the second end defining a longitudinal axis therebetween;
a securing means attached to the device body first end;
the device body comprising at least one projection projecting at an angle from the longitudinal axis of the device body; and
wherein the device body is rotatable about the axis relative to securing means.

2. The device as claimed in claim 1, wherein the at least one projection is releasably attached to the device body.

3. The device as claimed in claim 1, wherein the securing means is releasably attached to the device body.

4. The device as claimed in claim 1, wherein at least one projection comprises at least one safety marker.

5. The device as claimed in claim 1, wherein the at least one projection comprises a fluid flow means.

6. The device as claimed in claim 5, wherein the fluid flow means is selected from the group of; a curvature, a winglet, an undulation, an aperture, a bead, a rib, a stud, a rim, a lip or any other suitable means for altering the direction of a flow of fluid.

7. The device as claimed in claim 1, wherein the device body axis is offset from a transmission line.

8. The device as claimed in claim 1, wherein the securing means comprises a pair of jaws adapted to form an abutting relationship with a transmission line.

9. The device as claimed in claim 8, wherein the jaws comprise a plurality of prongs adapted to interleave relatively.

10. The device as claimed in claim 1, wherein the securing means is a longitudinal element adapted to be wound around a transmission line.

11. The device as claimed in claim 10, wherein the longitudinal element is formed with at least one predetermined shape from the group of; a conical shape, an hourglass shape, a barrel (concave) shape and a reduced end shape.

12. A device adapted for securing to a transmission line, the device comprising;
a device body having a first end and a second end;
a securing means attached to the first end of the device body adapted for securing the device to a transmission line;
the securing means comprising a manipulation means adapted for adjusting the securing means; and
wherein the manipulation means for the securing means can be adjusted from a location relatively above the transmission line.

13. The device as claimed in claim 12, wherein the securing means can be articulated relative to the device body.

14. The device as claimed in claim 12, wherein the device body comprises at least one projection.

15. The device as claimed claim 12, wherein the device body is rotatable relative to the securing means.

16. The device as claimed in claim 12, wherein the device body is removably attached to the securing means.

17. A device adapted for use as a warning marker, the device comprising;
a device body with a first end and a second end, the first end and the second end defining a longitudinal axis therebetween;
a securing means attached to the device body first end;
the device body comprising at least one projection projecting at an angle from the longitudinal axis of the device body; and
wherein the projections are removably attached to the device body.

18. The device as claimed in claim 17, wherein the projections comprise at least one curvature formation.

19. The device as claimed in claim 17, wherein the device further comprises at least one fluid flow means.

20. The device as claimed in claim 17, wherein the securing means comprises a first jaw and a second jaw adapted to be secured to a line.
